(19) United States
(12) Patent Application Publication
(10) Pub. No.: US 2013/0046700 A1
(43) Pub. Date: Feb. 21, 2013

(54) DISPUTE RESOLUTION SYSTEM AND METHODS THEREOF

(71) Applicant: Yaron Vilosny, New York, NY (US)

(72) Inventor: Yaron Vilosny, New York, NY (US)

(21) Appl. No.: 13/210,111

(22) Filed: Aug. 15, 2011

(51) Int. Cl. G06Q 10/00

(52) U.S. Cl. 705/309

(57) ABSTRACT

This disclosure relates to a dispute resolution system and methods thereof. In one illustrative embodiment, the system mimics a virtual courtroom operating over a communication network. A session can be created within the virtual courtroom by a plaintiff and defendant having a dispute. After determining an available time when both the plaintiff and defendant can meet as well as a moderator, invitations are sent to the plaintiff and defendant. These invitations can include access instructions and/or passwords. Before or during the session, supporting documents, videos, photos, etc. can be uploaded. When the session time arrives, the plaintiff and defendant can log in. Live streaming data can be provided by the plaintiff, defendant and moderator, who can each have a conferencing device or the like. Through the live streaming data, the moderator can facilitate a resolution of the dispute between the plaintiff and defendant.

### TECHNICAL FIELD

This disclosure generally relates to legal services, and more particularly, to facilitating dispute resolution through a virtual courthouse.

### BACKGROUND

Conflicts are inevitable in society, government and business. In many contexts, collaborative problem-solving can produce more sustainable, expansive and just outcomes than lengthy, divisive litigation. Alternative dispute resolution seeks to improve the quality of resolutions to respond to the most pressing domestic and global challenges of our day. Each year over 600,000 cases are filed in New York small claims court. Most courts encourage parties with disputes to seek alternative dispute resolution. One guiding principle usually operating in these courts is that individuals ought to be able to conduct their own cases and represent themselves without recourse to a lawyer.

Nevertheless, the ways we use and interact with the legal system have not changed with the web revolution. Today, when a dispute arises, participants can pursue a legal or arbitrary dispute through options that are limited or nonexistent. No such legal system exists for the masses. A need therefore exists for a system that provides dispute resolution while bringing legal rules of engagement to the web. These, as well as other related advantages, will be described in the present disclosure.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a method of establishing a dispute resolution platform is provided. The method can include creating a virtual conference for a plaintiff and defendant having a dispute and providing invitations for the virtual conference to the plaintiff and defendant. In addition, the method can include logging in the plaintiff and defendant into the virtual conference and receiving live streaming data from the plaintiff and defendant. The method can also include receiving live streaming data from a moderator and facilitating a resolution of the dispute between the plaintiff and defendant by the moderator through the live streaming data from the plaintiff, defendant and moderator.

In accordance with another aspect of the present disclosure, a system is provided. The system can include a server operating a virtual courthouse coupled to a communication network. A plaintiff and defendant to a dispute can login to the virtual courthouse over the communication network. The dispute between the plaintiff and the defendant can be resolved by a moderator connected into the virtual courthouse through the communication network.

In accordance with yet another aspect of the present application, a server replicating a virtual courthouse is provided. The server can include at least one processor and a memory operatively coupled to the processor, the memory storing program instructions that when executed by the processor, causes the processor to perform processes. These processes can include setting up a conference when a plaintiff, defendant and adjudicator are available. In addition, the processes can include connecting the plaintiff, defendant and adjudicator to the conference and establishing interactions between the plaintiff and defendant in the conference having a dispute. The processes can also include moderating the interactions by the adjudicator to resolve the dispute.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objectives and advantages thereof; will be best understood by reference to the following detailed description of illustrative embodiments when read in conjunction with the accompanying drawings, wherein:

FIG. 1 is a block diagram depicting an illustrative environment for a virtual courthouse in accordance with one or more aspects of the present disclosure;

FIG. 2 is a block diagram showing exemplary hardware and software components of a conference device in accordance with one or more aspects of the present disclosure;

FIG. 3 is a block diagram showing exemplary hardware and software components of a server for the virtual courthouse to operate on in accordance with one or more aspects of the present disclosure;

FIG. 4 is a flow chart depicting illustrative processes for setting up a dispute resolution through the virtual courthouse in accordance with one or more aspects of the present disclosure; and

FIG. 5 is a flow chart depicting illustrative processes generating fees through the virtual courthouse in accordance with one or more aspects of the present disclosure.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the present disclosure relates to legal proceedings. More specifically, this disclosure relates to a dispute resolution system and methods thereof. In one illustrative embodiment, the system mimics a virtual courtroom operating over a communication network. A session can be created within the virtual courtroom by a plaintiff or defendant having a dispute. A fee can be paid to start the session. After determining an available time when both the plaintiff and defendant can meet as well as a moderator, invitations are sent to the plaintiff and defendant. These invitations can include access instructions and passwords. Before or during the session, supporting documents, videos, photos, etc. can be uploaded. When the session time arrives, the plaintiff and defendant can log in. Live streaming data can be provided by the plaintiff, defendant and moderator, who can each have a conferencing device or the like. The moderator can then facilitate a resolution of the dispute between the plaintiff and defendant through the live streaming data. Content created from the resolution can be saved and then used to generate additional revenue.

A number of advantages can be offered by the illustrative embodiment described above. The system will change the legal market by using streaming video and audio conferencing technology. The virtual courthouse can bring legal rules of engagement to the web. Disputes can be resolved by real people who can stream live video and audio twenty four (24) hours a day seven (7) days a week. Through the help of a professional mediator or judge, a reliable alternative to the current legal system is provided. The whole session can also be broadcasted live to give an audience a chance to share, interact, remark, rate and be part of the process. Many additional advantages of the present disclosure will become apparent to those skilled in the relevant art as provided for in the following description.

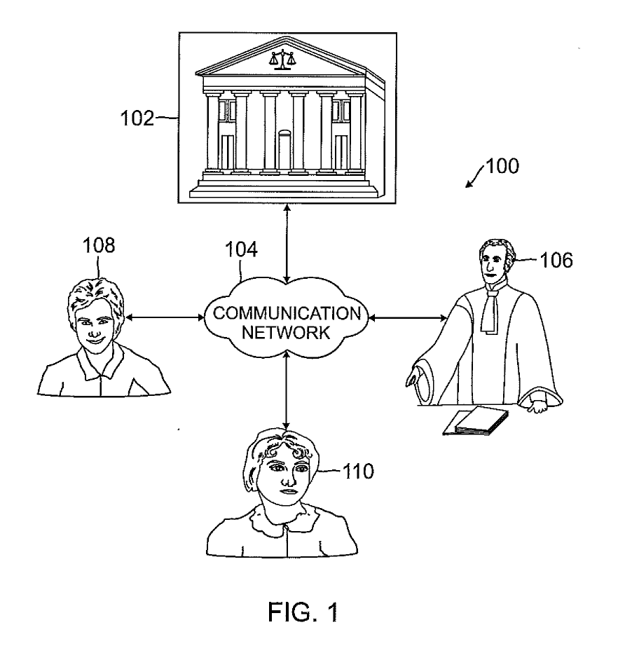

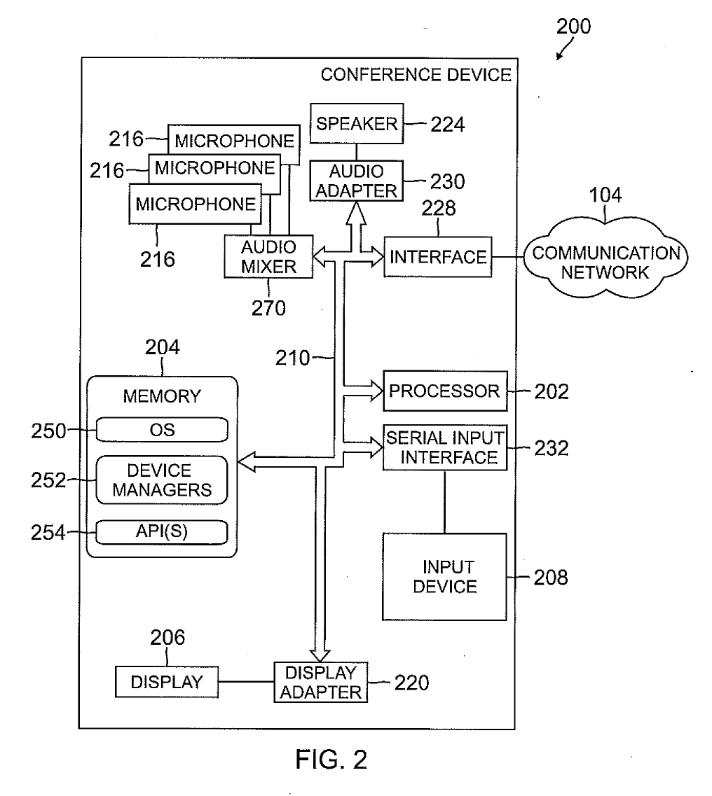

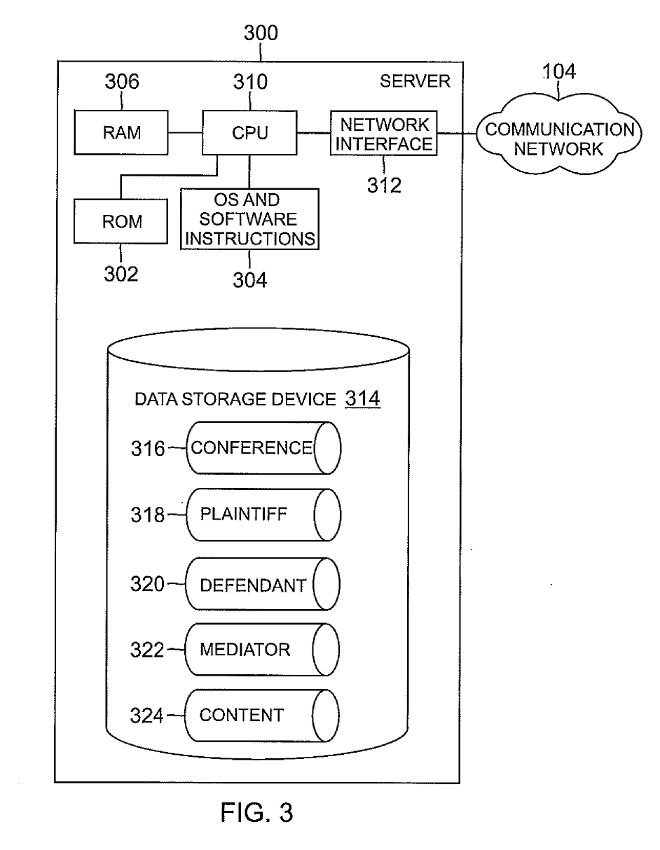

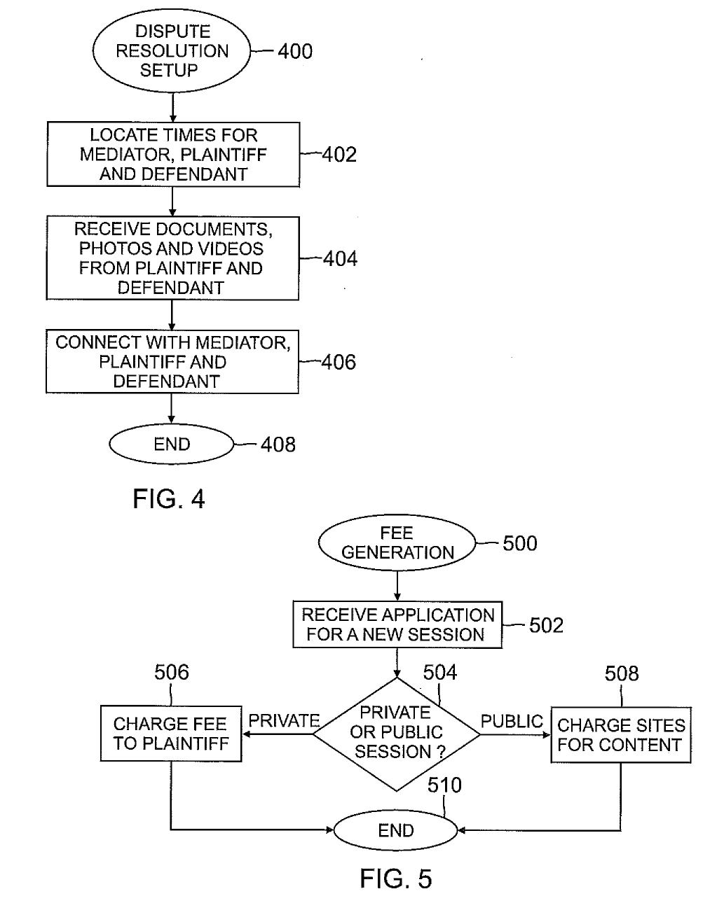

Before describing embodiments of the present disclosure, an exemplary environment for which the dispute resolution system can operate in is provided in FIG. 1. Thereafter, a typical conference device is provided in FIG. 2 and an illustrative server for operating the virtual courthouse shown in FIG. 3 will be described. FIG. 4 will provide an exemplary flow chart for depicting processes to setup the virtual courthouse, while FIG. 5 shows illustrative fee generation processes. A moderator, for purposes of the present disclosure, can also be referred to as a judge, mediator or adjudicator. Furthermore, the features described herein do not necessarily have to occur in an alternative dispute resolution arena. Those skilled in the relevant art will appreciate that these concepts can be implemented in other facets of the legal system, for example, discovery, pretrial conferences, etc. Also, while video conferencing devices are typically used, dial in devices without video can also be implemented into the system.

Turning now to FIG. 1, a block diagram depicting an illustrative environment 100 for a virtual courthouse 102 in accordance with one or more aspects of the present disclosure is provided. The environment, as shown, can include a virtual courthouse 102 connected to a plaintiff 108 and defendant 110 as well as a mediator 106 through a communication network 104. Fewer or more parties can be connected to the virtual courthouse 102 and will become apparent from the discussion provided below. For example, the virtual courthouse 102 can be used in a class action suit where multiple defendants 110 or plaintiffs 108 are present.

Communications provided by the plaintiff 108, defendant 110 and mediator 106 through the communication network 104 can occur through a wireline or wireless connection. The communication network 104 can include a local area network (LAN), wide area network (WAN), personal area network (PAN), campus area network (CAN), metropolitan area network (MAN), global area network (GAN), or combination thereof. Such networking environments are commonplace in office networks, enterprise-wide computer networks, intranets and the Internet, which are all types of networks.

In one embodiment, the plaintiff 108, defendant 110 and moderator 106 communicate at only certified locations. For example, the plaintiff 108 and defendant 110 could log into the virtual courthouse 102 at designated collaboration areas that provide a secure environment while the moderator 106 can be logged into the virtual courthouse 102 at the actual courthouse. In an alternative embodiment, the parties can be logged in through a home or office connection having a more relaxed feel to it. Different combinations can be used and is dependent on the implementation of the virtual courthouse 102 and requirements of the parties.

The virtual courthouse 102 provides an out-of-location driven legal proceeding so that parties can connect, upload case materials, review those materials and handle them in an appropriate manner. In essence, the system provided herein mimics legal proceedings that otherwise would require all parties to be present at the same location. FIG. 2 is a block diagram showing exemplary hardware and software components of a conference device 200 in accordance with one or more aspects of the present disclosure. The conference device 200, or similar devices, can be used to resolve disputes between the plaintiff 108 and defendant 110. Other devices known to those skilled in the relevant art can also be used and the present disclosure is not limited to communications through the conference device 200 shown. For example, devices having no video capabilities can be used. Furthermore, devices having smartphone capabilities can also be used.

The conference device 200 can include a processor 202 for implementing logic, memory 204, display 206, and input device 208. A system bus 210 can be used for video and audio data as well as propagating signals for processing the video and audio. On the display 206 of the conference device 200, a touch-screen interface can be provided. The display 206 can be a color multi-touch liquid crystal display (LCD) that provides a user interface for the conference device 200. The display 206 can be connected to a display adapter 220. The display adapter 220 can receive information for display from the bus 210. The display 206 can also be used as an input device 208. The input device 208 can be connected to the system bus 210 through a serial input interface 232.

The memory 204 generally includes both volatile memory (e.g., RAM) and non-volatile memory (e.g., ROM, Flash Memory, or the like). The non-volatile portion of the memory 204 can be used to store persistent information which should not be lost when powered down. The conference device 200 can include an operating system (OS) 250, such as Google's Android™ or Windows Mobile™ available from Microsoft®, or other OS. The OS 250 can reside in the memory 204 and be executed on the processor 202. The memory 204 can also include one or more device managers 252 for interacting with one or more I/O devices. The device managers 252 can be software installed on the conference device 200. A device manager 252 can correspond to each 110 device. The memory 204 can also include a collection of one or more application programming interfaces (APIs) 254 for facilitating communication between the conference device 200 and one or more remote devices. The APIs 254 be invoked by the applications to recognize and control the one or more remote I/O devices. In this manner, the conference device 200 is able to take advantage of services or functionalities of the one or more remote I/O devices. The conference device 200 can have an array of microphones 216 built-in as with any standard conference phone. The audio from the microphones 216 can be provided to the audio mixer 270. The conference device 200 can include a speaker 224. The speaker 224 can propagate incoming audio received from the communication network 104 through the interface 228. These communications can then be provided over the bus 210 to the audio adapter 230.

Referring to FIG. 3, a block diagram showing exemplary hardware and software components of a server 300 for the virtual courthouse 102 to operate on in accordance with one or more aspects of the present disclosure is provided. The server 300 typically takes the form of a computer server, and more specifically a web server. The server 300 can process data as well as live conferencing video and audio. The server 300 can include ROM 302, operating system and software instructions 304, RAM 306, central processor (CPU) 308, network interface 312 connected to the communication network 104 and data storage device 314. A conventional personal computer or computer workstation with sufficient memory and processing capability can be used as the server 300. Alternatively, multiple interconnected servers can also serve as the server 300.

The server 300 can handle high volumes of transactions and large amount of queries for communication and data processing. Documents, videos, photos or other relevant information to a dispute can be processed on-the-fly or pre-fetched by the server 300. The server 300 can also receive streaming data, such as conference data, from the plaintiff 108, defendant 110 and the moderator 106. These live data streams can be processed by the server 300 and sent to other parties within the conference such that each party can be sent multiple streams. In one embodiment, the server 300 can combine the data streams into a single display for the plaintiff 108, defendant 110 and moderator 106. Operations can be implemented within the server 300 to prevent distribution of these streams, which will become apparent from the description provided below.

RAM 306 and ROM 302 are used to support the program codes that are operated by the CPU 310. The memory can be in a faun of a hard disk, CD ROM, or equivalent storage medium. The CPU 310 can support the authentications such as communications from external data servers, as well as allowing for anonymous transactions and general data encryption. The data storage device 314 can include hard disk magnetic or optical storage units, as well as CD ROM, CD RW or DVD ROM and flash memory such as compact flash and secure digital cards. The data storage device 314 contains databases used in the processing of transactions including conference database 316, plaintiff database 318, defendant database 320, mediator database 322 and content database 324. Data can flow from each of the databases and can be interconnected through logical or physical connections.

The conference database 316, in one embodiment, can keep track of conference details. These details can include the times and dates of conferences. These details can be stored once a conference has been established by the plaintiff 108, defendant 110 or moderator 106. The plaintiff database 318 and defendant database 320 can store specific information on each of these parties. A conference instance within the conference database 316 can be linked with at least one plaintiff 108 in the plaintiff database 318 and at least one defendant 110 in the defendant database 320. It should be understood that while a plaintiff 108 and defendant 110 are described as those parties being in a conference, in some embodiments, only plaintiffs 108 or only defendants 110 can be part of a conference instance, for example, allowing them to determine strategies or exit class actions. These databases 318 and 320 can maintain documents, files, photos, videos or other information that can be used in a dispute, Timing schedules for both parties can also be stored within these databases 318 and 320 as well.

A mediator database 320 can store information about mediators 106. This information can include schedules and times of the mediators so that they can be fit into a specific conference instance for the plaintiff 108 and defendant 110. Other information stored within the database 320 can include the mediator's specialties. For example, some mediators 106 can be experienced with intellectual property issues, while others can be more knowledgeable about criminal issues. A content database 322 can also be stored within the data storage device 314. The content database 322 can be used to store information regarding materials used to resolve disputes. For example, the conversation and tactics used to moderate the dispute can be kept. This content can be later accessed by others. A voice-to-text component can be provided within the database 322. While specific information was described within each of the databases, the data can be distributed among them and are not limited to any single database.

The server 300 can include a network interface 312 in order to communicate with other components over the communication network 104. For example, plaintiffs, defendants and moderators trying to access the server 300 will typically log in through the communication network 104. As another example, third-parties can access server 300 and content database 322, typically through the communication network 104. Conventional internal or external modems can serve as a network interface 312. A cable or DSL modem can be used as a network interface 312. The network interface 312 can support modems at a range of baud rate from 2400 and upwards.

While the above embodiment describes a single computer system acting as the server 300, the functionality can be distributed over multiple computing systems. The databases can also be distributed over a cloud computing environment. In one embodiment, the server 300 is configured in a distributed architecture, wherein the databases and processors are housed in separate units or locations. Some servers perform the primary processing functions and contain at a minimum RAM, ROM, and a general processor. Each of these servers is attached to a WAN hub which serves as the primary communication link with the other servers and interface devices. The WAN hub can have minimal processing capability itself, serving primarily as a communications router. Those skilled in the art will appreciate that an almost unlimited number of controllers can be supported. This arrangement yields a more dynamic and flexible system, less prone to catastrophic hardware failures affecting the entire system.

Through this configuration, streaming video conferencing technology can be used to create virtual courthouses that bring legal rules of engagement to the World Wide Web (WWW).

FIG. 4 is a flow chart depicting illustrative processes for setting up a dispute resolution through the virtual courthouse 102 in accordance with one or more aspects of the present disclosure. While primarily being described as used in a dispute resolution environment 100 depicted above, those skilled in the relevant art will appreciate that these processes can be applied to legal environments where conversations are enhanced by a mediator 106. Fewer or more processes can be used. These processes can begin at block 400.

A conference instance can be initiated by either a plaintiff 108 or defendant 110 to a dispute. Alternatively, the instance can be generated by an official affiliated with the court system. A website offered by the server 300 can allow a plaintiff 108 or defendant 110 to begin the conference instance. The plaintiff 108 or defendant 110 can login to the server 300 operating the virtual courthouse 102. Information about the conference can then be established by the plaintiff 108 or defendant 110. For example, the subject of the conference or the parties to the dispute can be entered in.

At block 402, the server 300 operating the virtual courthouse 102 can locate times for the mediator 106, plaintiff 108 and defendant 110 for which they can attend the conference. In one embodiment, the schedules for the plaintiff 108 in the plaintiff database 318, the defendant 110 in the defendant database 320 and the mediator 106 in the mediator database 322 within the data storage device 314 can be retrieved from their scheduling application such as Microsoft® Outlook. The server 300 can process this information and determine times when all of them can meet. In one embodiment, the mediator 106, plaintiff 108 and defendant 110 can input their own times into the server 300. Generally, the mediator 106 is separate from the plaintiff 108 and defendant 110 and has a set schedule of times when they can meet for the conference.

After determining times when the mediator 106, plaintiff 108 and defendant 110 can meet, invitations to the conference can be sent. A number of times for the conference can be sent and the mediator 106, plaintiff 108 and defendant 110 can respond to the invitation electronically. For example, the invitation can list that the mediator 106, plaintiff 108 and defendant 110 can meet virtually on July 12^{th} at 1:00 PM, July 14^{th} at 3:00 PM and July 14^{th} at 5:00 PM. Each party associated with the dispute resolution can select one or more of those times so that a final meeting time for the conference can be setup. The invitation can be sent via electronic mail or through some other communication method.

Within the invitation to the conference, a set of instructions can be provided to the mediator 106, plaintiff 108 and defendant 110 that detail how to access the access the conference at the virtual courthouse 102, In one embodiment, these instructions can include passwords, usernames, etc. The passwords and usernames can be the same or different for the mediator 106, plaintiff 108 and defendant 110. At the agreed upon time of the conference, the mediator 106, plaintiff 108 and defendant 110 can use this information to access the conference. In one embodiment, the usernames and passwords can change each time such that the conference has a limited purpose. Alternatively, the usernames and passwords can be kept so that parties to the conference can be aware of all their scheduled conferences. For example, it would be beneficial that a mediator 106 has the same password each time to enter into conferences between different plaintiffs 108 and defendants 110 regardless of whether new plaintiffs 108 and defendants 110 are present.

When a mediator 106 is unable to make a scheduled conference, the server 300 can be notified and find a new mediator 106 that can resolve the dispute. New invitations would be sent to the mediator 106, plaintiff 108 and defendant 110 displaying times when each party can attend the conference. Reminders can be sent to the mediator 106, plaintiff 108 and defendant 110. Reminders can also be sent more frequently as the time for the conference approaches.

At block 404, documents, photos, videos and any other pertinent information can be uploaded by the plaintiff 108 and defendant 110. The information is typically provided before the conference begins, but as will become apparent from the discussion below, can be uploaded or sent at anytime during and even after the conference. This data can be stored into the plaintiff database 318 and defendant database 320 depending on which party uploaded the information.

At block 406, the server 300 operating the virtual courthouse 102 can connect with the mediator 106, plaintiff 108 and defendant 110. In one embodiment, the username and passwords provided in the invitations can be used to access the virtual courthouse 102. After connecting with the mediator 106, plaintiff 108 and defendant 110, the virtual courthouse 102 can provide an interface for those parties to interact. A three-dimensional interface can be provided having avatars for each of the parties involved in the conference. Before the conference takes place, those documents or data earlier provided can be sent to each of the parties either through their conference device 200, their electronic mail addresses, etc.

Through the virtual courthouse 102, live data streams can be provided by the mediator 106, plaintiff 108 and defendant 110. These data streams can be sent to the virtual courthouse 102 whereby the virtual courthouse 102 can then resend them to each of the participating parties within the conference. Alternatively, the virtual courthouse 102 operating on the server 300 can manipulate the data streams such that only one combined stream is sent to each of the users. Through these data streams along with the previously uploaded information, the mediator 106 can then make judgments to facilitate the discussion so that the plaintiff 108 and defendant 110 can come to a resolution.

The live data streams can be provided through web cams associated with the mediator 106, plaintiff 108 and defendant 110. Other visual and auditory devices known to those skilled in the relevant art can be used and streamed into the virtual courthouse 102. The plaintiff 108 and defendant 108 can present their case using the webcam or mobile video, upload supporting documents, photos, and video, if necessary. Typically, they would broadcast through a web-cam from the comfort of their home or office, interacting with each other, or just the mediator 106. In one embodiment, an audience can view the conference. The whole session can be broadcasted live to give the audience a chance to share, interact, remark, rate and be part of the process.

Through the virtual courthouse 102, the mediator can apply legal rules and regulations to the dispute between the plaintiff 108 and defendant 110. In one embodiment, the moderator 106 can operate controls limiting the conversation between the participants. For example, the moderator 106 can prevent the live data streams from going from the plaintiff 108 to the defendant 110 and from the defendant 110 to the plaintiff 108 when appropriate. Certain situations can exist where the moderator 106 would want audio and/or video from being sent, for example, when the parties are becoming argumentative. The moderator 106, by doing this, can “cool” the situation down and provide a more meaningful platform for resolving the dispute. Furthermore, the moderator 106 can setup the system such that the virtual courthouse 102 can be used for a more functional process allowing each party to speak without interruption. The processes can end at block 408. Generally this occurs when a resolution to the dispute has occurred or the parties cannot come to an agreement.

FIG. 5 is a flow chart depicting illustrative processes for generating fees through the virtual courthouse 102 in accordance with one or more aspects of the present disclosure. A number of different techniques known to those skilled in the relevant art can be used to generate fees beyond those described below. For example, lawyer services or other general advertising matters can be displayed by the virtual courthouse 102 through the server 300. Processes for generating fees can begin at block 500 with fewer or more processes capable of being inserted or removed into or form the flow chart.

At block 502, the server 300 operating the virtual courthouse 102 can receive an application or instantiation for a new session. As described earlier, the plaintiff 108 or defendant 110 can generate this application. At decision block 504, the server 300 can determine whether the session is to be public or private. Generally, if a fee is paid at block 506, the conference between the plaintiff 108 and defendant 110 is private. Private conversations are those that will only be disclosed to those parties involved and no outside parties will be able to access the content.

Alternatively, at block 508 and when the conference is public, the content produced from the conference can be stored within the content database 322 of the server 300. This content can be sold or licensed to other sites. In one embodiment, the content can be provided through a live feed. The content can also be edited before it is sent out to other parties. In one embodiment, the content through the live streaming data can be converted into a transcript. Software known to those skilled in the relevant art can be used for the conversion. The processes for fee generation can end at block 510.

In accordance with one aspect of the present disclosure, a method of establishing a dispute resolution platform is provided. The method can include creating a virtual conference for a plaintiff and defendant having a dispute and providing invitations for the virtual conference to the plaintiff and defendant. In addition, the method can include logging in the plaintiff and defendant into the virtual conference and receiving live streaming data from the plaintiff and defendant. The method can also include receiving live streaming data from a moderator and facilitating a resolution of the dispute between the plaintiff and defendant by the moderator through the live streaming data from the plaintiff, defendant and moderator.

In one embodiment, creating a virtual conference can include receiving a conference request by the plaintiff and in response to the conference request, determining a time when the plaintiff, defendant and moderator are available. In one embodiment, determining the time when the plaintiff, defendant and moderator are available can include receiving schedules of the plaintiff, defendant and moderator from a calendar application. In one embodiment, determining the time when the plaintiff, defendant and moderator are available can include selecting a new moderator when the moderator is unavailable at the time.

In one embodiment, providing the invitations for the virtual conference to the plaintiff and defendant comprises transmitting the invitations via email having instructions and passwords for accessing the virtual conference. In one embodiment, logging in the plaintiff and defendant to the virtual conference can include receiving the password from the plaintiff and defendant. In one embodiment, the method can include retrieving supporting documents from at least one of the plaintiff, the defendant, and combination thereof.

In accordance with another aspect of the present disclosure, a system is provided. The system can include a server operating a virtual courthouse coupled to a communication network. A plaintiff and defendant to a dispute can login to the virtual courthouse over the communication network. The dispute between the plaintiff and the defendant can be resolved by a moderator connected into the virtual courthouse through the communication network.

In one embodiment, the plaintiff and the defendant to the dispute can upload at least one of a document, photo and video to the server operating the virtual courthouse. In one embodiment, the plaintiff, defendant and moderator can interact with one another in the virtual courthouse through live video dialogue. In one embodiment, the live video dialogue can be provided through web cams associated with the plaintiff, defendant and moderator. In one embodiment, the moderator can resolve the dispute by monitoring the live video dialogue and disabling the live dialogue by either the plaintiff or defendant when appropriate. In one embodiment, the live video dialogue can be converted into a transcript. In one embodiment, the virtual courthouse can be compatible only at certified locations.

In accordance with yet another aspect of the present application, a server replicating a virtual courthouse is provided. The server can include at least one processor and a memory operatively coupled to the processor, the memory storing program instructions that when executed by the processor, causes the processor to perform processes. The processes can include setting up a conference when a plaintiff, defendant and adjudicator are available and connecting the plaintiff, defendant and adjudicator to the conference. In addition, the processes can include establishing interactions between the plaintiff and defendant in the conference having a dispute. The processes can also include moderating the interactions by the adjudicator to resolve the dispute.

In one embodiment, wherein the memory storing program instructions, when executed by the processor, can cause the processor to receive a list of times for the conference by the plaintiff or defendant. In one embodiment, the interactions can be live. In one embodiment, wherein the memory storing program instructions, when executed by the processor, can cause the processor to receive a fee to setup the conference.

In one embodiment, wherein the memory storing program instructions, when executed by the processor, can cause the processor to save content from the conference and provide the content to others for a fee. In one embodiment, wherein the memory storing program instructions, when executed by the processor, can cause the processor to upload at least one of a document, video and photo.

The data structures and code described in this detailed disclosure are typically stored on a non-transitory computer-readable storage medium, which can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed disclosure section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein can be implemented as logical operations and/or modules. The logical operations can be implemented as a sequence of processor-implemented executed steps and as interconnected machine or circuit modules. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

In software implementations, computer software and/or data is stored on a machine readable medium as part of a computer program product, and is loaded into a computer system or other device or machine via a removable storage drive, hard drive, or communications interface. Computer programs, also called computer control logic or computer readable program code, are stored in a main and/or secondary memory, and executed by one or more processors, controllers, or the like to cause the one or more processors to perform the functions of the disclosure as described herein.

The figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present disclosure, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A method of establishing a dispute resolution platform comprising:
creating a virtual conference for a plaintiff and defendant having a dispute;
providing invitations for said virtual conference to said plaintiff and defendant;
logging in said plaintiff and defendant into said virtual conference;
receiving live streaming data from said plaintiff and defendant;
receiving live streaming data from a moderator; and
facilitating a resolution of said dispute between said plaintiff and defendant by said moderator through said live streaming data from said plaintiff, defendant and moderator.

2. The method of claim 1, wherein creating a virtual conference comprises receiving a conference request by said plaintiff and in response to said conference request, determining a time when said plaintiff, defendant and moderator are available.

3. The method of claim 2, wherein determining said time when said plaintiff, defendant and moderator are available comprises receiving schedules of said plaintiff, defendant and moderator from a calendar application.

4. The method of claim 2, wherein determining said time when said plaintiff, defendant and moderator are available comprises selecting a new moderator when said moderator is unavailable at said time.

5. The method of claim 1, wherein providing said invitations for said virtual conference to said plaintiff and defendant comprises transmitting said invitations via email having instructions and passwords for accessing said virtual conference.

6. The method of claim 5, wherein logging in said plaintiff and defendant to said virtual conference comprises receiving said password from said plaintiff and defendant.

7. The method of claim 1, comprising retrieving supporting documents from at least one of said plaintiff, said defendant, and combination thereof.

8. A system comprising:
a server operating a virtual courthouse coupled to a communication network;
wherein a plaintiff and defendant to a dispute login to said virtual courthouse over said communication network, said dispute between said plaintiff and said defendant resolved by a moderator connected into said virtual courthouse through said communication network.

9. The system of claim 8, wherein said plaintiff and said defendant to said dispute upload at least one of a document, photo and video to said server operating said virtual courthouse.

10. The system of claim 8, wherein said plaintiff, defendant and moderator interact with one another in said virtual courthouse through live video dialogue.

11. The system of claim 10, wherein said live video dialogue is provided through web cams associated with said plaintiff, defendant and moderator.

12. The system of claim 10, wherein said moderator resolves said dispute by monitoring said live video dialogue and disabling said live dialogue by either said plaintiff or defendant when appropriate.

13. The system of claim 10, wherein said live video dialogue is converted into a transcript.

14. The system of claim 8, wherein said virtual courthouse is compatible only at certified locations.

15. A server replicating a virtual courthouse comprising:
at least one processor; and
a memory operatively coupled to said processor, said memory storing program instructions that when executed by said processor, causes said processor to:
setup a conference when a plaintiff, defendant and adjudicator are available;
connect said plaintiff, defendant and adjudicator to said conference;
establish interactions between said plaintiff and defendant in said conference having a dispute;
moderate said interactions by said adjudicator to resolve said dispute.

16. The server of claim 15, wherein said memory storing program instructions, when executed by said processor, causes said processor to receive a list of times for said conference by said plaintiff or defendant.

17. The server of claim 15, wherein said interactions are live.

18. The server of claim 15, wherein said memory storing program instructions, when executed by said processor, causes said processor to receive a fee to setup said conference.

19. The server of claim 15, wherein said memory storing program instructions, when executed by said processor, causes said processor to save content from said conference and provide said content to others for a fee.

20. The server of claim 15, wherein said memory storing program instructions, when executed by said processor, causes said processor to upload at least one of a document, video and photo.
